(19) United States
(12) Patent Application Publication
(10) Pub. No.: US 2011/0126475 A1
(43) Pub. Date: Jun. 2, 2011

(54) Lower seal

(76) Inventors: Takashi Fukushima, Hiroshima (JP); Koso Deguchi, Hiroshima (JP)

(21) Appl. No.: 12/924,340

(22) Filed: Sep. 24, 2010

(30) Foreign Application Priority Data
Dec. 1, 2009 (JP) 2009-273040

(51) Int. Cl. E06B 7/22

(52) U.S. Cl. 49/493.1

(57) ABSTRACT

In a lower seal composed of a mounting part 5 to be mounted to a door panel 3 by a clip 4, a main lip 6 that is provided in a protruding state by bending from the upper end of the mounting part toward the inside of a vehicle and a sub-lip 22 that is integrally formed in the lower end of the mounting part, and that covers a drainage hole 12 by elastically making contact with a paint sealer 11 mounted to a hem 9; a folding part 23 with a V-shaped cross section is formed in the sub-lip 22 so as not to damage the lower seal, because the folding part 23 makes contact with the margin of the insertion groove 17 and is folded and the lower end of the sub-lip 22 is drawn from the hem 9 and tucked by the pedestal 16 when the door panel 3 after mounting of the lower seal is carried to a cradle for the next process.

### FIELD OF THE INVENTION

The present invention relates to a lower seal that is mounted at the lower end of the side door of a vehicle, and that seals a between body gap when the door is closed.

### BACKGROUND OF THE INVENTION

A lower seal 2 for sealing a between body gap when a door is closed is mounted at the lower end of the side door of the vehicle shown in FIG. 1.

FIG. 2 shows a cross section of the lower seal 2 along the A-A line of FIG. 1, and the lower seal 2 is composed of a mounting part 5 to be mounted to a door panel 3 by a clip 4, a main lip 6 that curves and protrudes toward the inside of the vehicle from the upper end of the mounting part, and a sub-lip 7 that extends downward from a mounting part 5, wherein the main lip 6 is designed to bow due to hitting a body 8 when the door is closed, and to seal a gap in between the body 8 by elastically making contact with the body 8. An example of this type of lower seal is disclosed in Japanese Unexamined Patent Application Publication 2007-210385.

A sub-lip 7 extends toward a hem 9 of the door panel 3, and elastically makes contact with a paint sealer 11 to be applied over the hem 9 for the purpose of corrosion control; seals and covers a drainage hole 12 formed in the door panel 3 on the paint sealer; and is designed to prevent outside noises from entering into the vehicle through the drainage hole 12. Furthermore, water flowing out through the drainage hole 12 is received by the sub-lip 7 that flexibly makes contact with the paint sealer 11, and is discharged to the outside from the end of the sub-lip.

The lower seal 2 is assembled to the door panel 3 normally as described below.

First, the door panel 3 is mounted to a cradle 14 as shown in FIG. 3. The illustrated cradle 14 is composed of a platform 15 and pedestals 16 that are mounted or supported to the platform 15, and for example, a groove with a V-shaped cross section 17, which is schematically shown in FIG. 4, is formed in the pedestal 16, respectively, and the door panel 3 is mounted by being inserted into the V-shaped grooves 17 of the pedestals 16, respectively.

After the door panel 3 is mounted to the pedestals 16, the lower seal 2 is mounted to the lower edge of the door panel (FIG. 5). The reason the cradle 14 is used for the assembly work to assemble the lower seal 2 to the door panel 3 is to eliminate any works requiring squatting and makes the working posture more comfortable.

For the assembly work to a door, there are various works, such as window glazing or speaker mounting, other than mounting of the lower seal 2, and because there is a next process normally after the lower seal mounting, as well, the assembly is carried to another cradle, and mounting is performed. At this time, the sub-clip 7 assembled to the door panel 3 can become stuck between the pedestals 16 causing damage.

In order to avoid this problem, as shown in FIG. 6, countermeasures to mount the lower seal 2 within the range between the pedestals 16 or to notch the lower seal 2 for enabling it to be turned by the pedestals 16 to be a flap-state are adopted.

The reason the lower seal is mounted within the range between the pedestals as shown in FIG. 6 is because there is the difficulty that noise barrier performance may be lowered in sections of the pedestals without a corresponding lower seal, and notching of the lower seal also causes an increase of the number of processes and increases cost. Further, even with any of the above methods, if the positions of the pedestals become different on the cradle for the next process, the lower seal may intervene with the pedestals or the lower seal may be deformed by intervening with the pedestals because the lower seal is not turned at the necessary sections.

### SUMMARY OF THE INVENTION

The present invention is aimed at preventing deformation of the lower seal by intervening with the pedestals when the door panel where the lower seal is mounted is carried to the cradle for the next process and is mounted by inserting it into the insertion grooves of the pedestals in the cradle.

The present invention, therefore, is the lower seal that is mounted to the lower edge of the side door of a vehicle for this purpose, and that is composed of a mounting part to be mounted to a door panel, a seal part that is provided in a protruding state from the mounting part toward the inside of the vehicle and seals by elastically making contact with the body when the door is closed, and a sub-lip that extends from the mounting part, and that covers a drainage hole formed in the door panel on a hem by elastically making contact with the hem of the door panel, wherein the sub-lip is configured to be bendable by having a flexure part or a folding part.

Other features and effects of the present invention will be more clearly understood in the following detailed description of the embodiments by those skilled in the art. It must be, however, noted that the technical scope of the present invention is not limited to the embodiments and the accompanying drawings alone.

### BRIEF DESCRIPTION OF THE DRAWINGS

FIG. 1 is a schematic front view of a side door of a vehicle viewing from the inside of the vehicle.

FIG. 2 is a cross sectional view along the A-A line of FIG. 1.

FIG. 3 shows a situation where the side door is mounted to pedestals of a cradle.

FIG. 4 is a cross sectional view along the B-B line of FIG. 3.

FIG. 5 shows a situation where the door panel, where the lower seal is mounted is mounted, is mounted to the pedestals of another cradle for the next process.

FIG. 6 shows a situation where the lower seal is mounted between the pedestals.

FIG. 7 is a cross sectional view of the lower seal mounted to the door panel relating to the present invention along the A-A line of FIG. 1.

FIG. 8 is a cross sectional view when the door panel, where the lower seal is mounted, is mounted to the pedestals of the cradle for the next process.

FIG. 9 is a cross sectional view of the lower seal after being mounted to the pedestals.

FIG. 10 is a cross sectional view of a modified form of the lower seal.

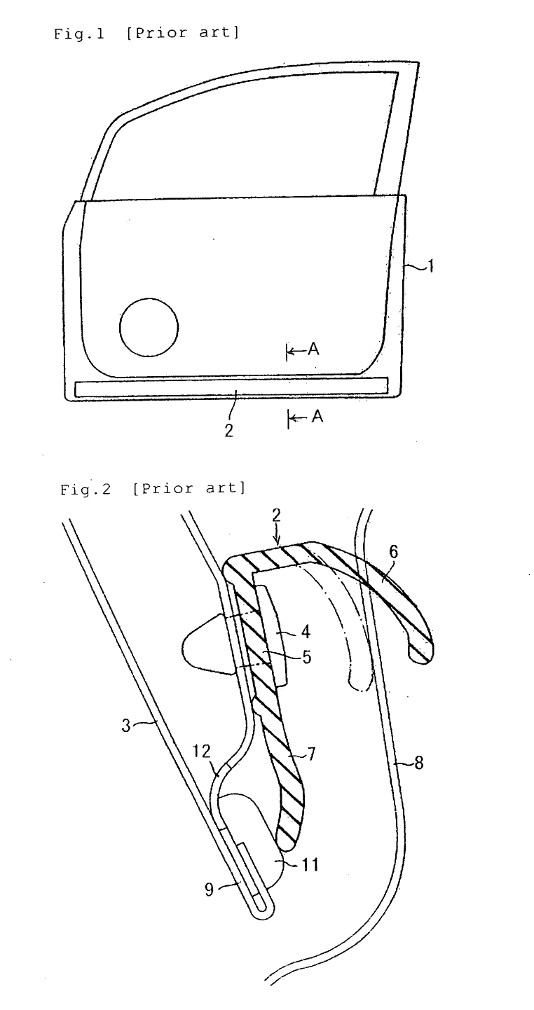

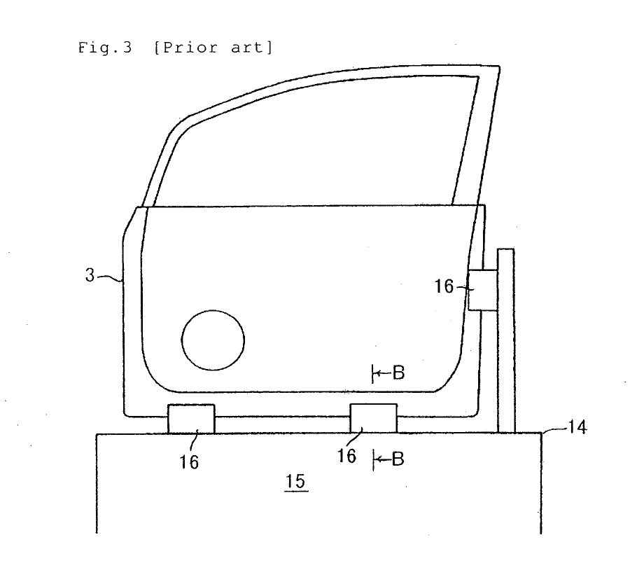

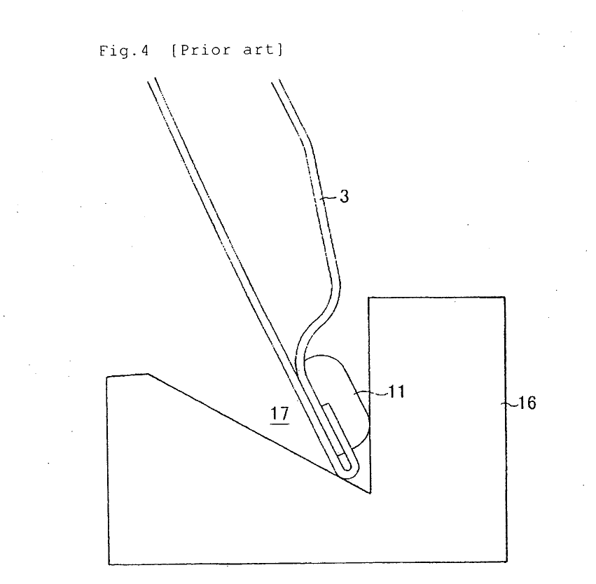

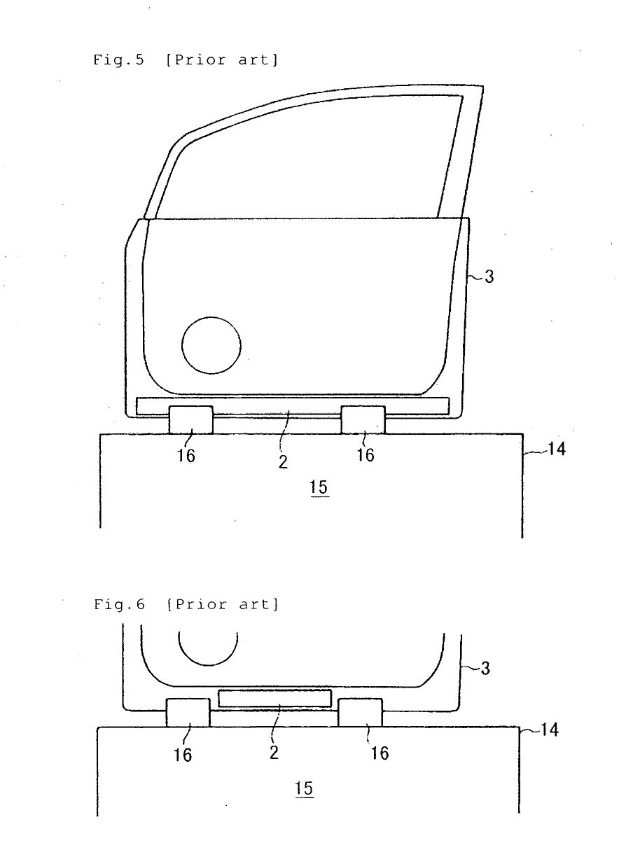

### DETAILED DESCRIPTION OF THE PREFERRED EMBODIMENT

The lower seal relating to an embodiment of the present invention to be mounted to a door panel is explained hereafter with reference to the drawings.

In the drawings, components, which are the same as those in the lower seal 2 shown in FIG. 2, are marked with the same symbols.

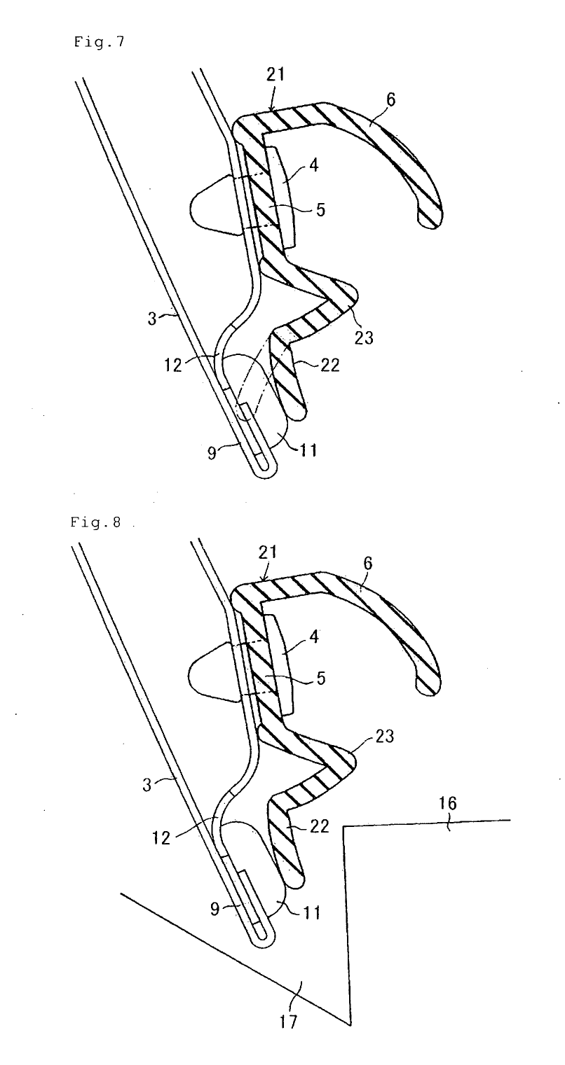

FIG. 7 shows a lower seal 21 of the present embodiment, and is composed of the mounting part 5 to be mounted to the door panel 3 by the clip 4, the main lip 6 that is provided in a protruding state by bending it from the upper end of the mounting part toward the inside of the vehicle as a seal part, and a sub-lip 22 that is integrally formed in the lower end of the mounting part, and the sub-lip 22 has a folding part 23 that has a V-shaped cross section and protrudes toward the inside of the vehicle, and the lower end elastically makes contact with the paint sealer 11 to be mounted to the hem 9 for corrosion control, and the entire sub-lip covers the drainage hole 12 formed in the door panel 3 on the paint sealer for blocking any outside noises from entering into the inside through the drainage hole 12.

After the mounting process of the lower seal 21, the door panel 3 is carried to a cradle for the next process, and when mounting the door panel 3 by insertion into insertion grooves 17 formed in the pedestals 16 of the cradle 14 as shown in FIG. 8, if the folding part 23 is folded and makes contact with the pedestal 16 at the margin, preventing the folding part 23 from being tucked between the pedestals 16 as shown in FIG. 9, preventing damage of the sub-clip 22 from occurring due to tucking.

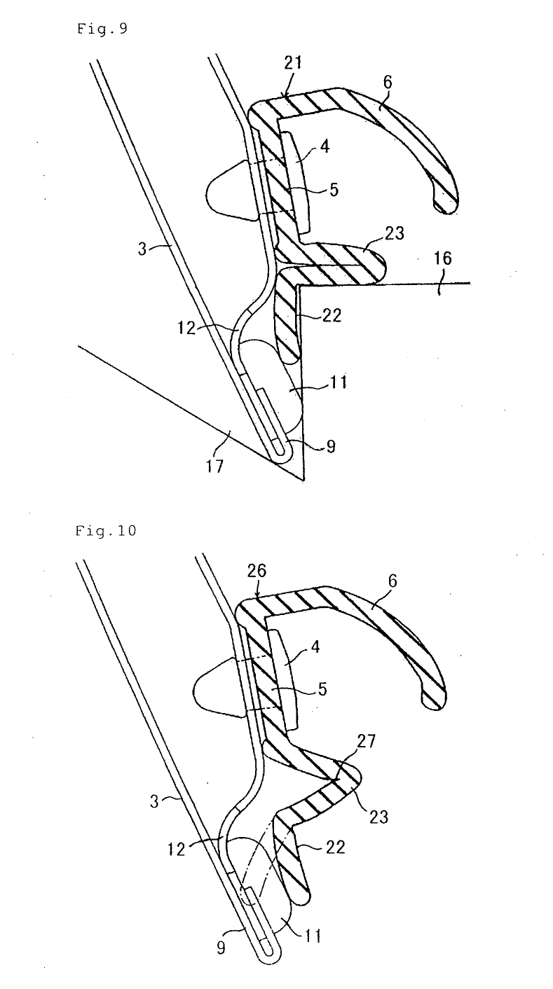

FIG. 10 shows a lower seal 26 in a modified form, and the points of difference in this lower seal 26 from the lower seal 21 shown in FIG. 7 facilitate folding at the folding part 23 by forming a notch 27 to assuredly draw in the lower end of the sub-lip as shown in FIG. 9, and in lieu of forming the notch 27, the folding part 23 may be made thinner.

In the lower seal of the embodiment, the main lip 6 is mentioned as a seal part to be provided in a protruding state toward the inside of a vehicle, but the seal part can be a hollow seal part.

Furthermore, although the illustrated insertion groove 17 formed in the pedestal 16 is simplified to be V-shaped, the actual insertion groove of the pedestal 16 may be slightly complicated. In either case, when the door panel 3 is inserted into the insertion groove, the folding part makes contact with the margin and is designed to remain folded.

What is claimed is:

1. A lower seal, comprising:
a mounting part to be mounted to a lower edge of a door panel of a vehicle;
a seal part that protrudes from the mounting part toward the inside of the vehicle, and that seals by elastically making contact with a body when the door is closed; and
a sub-lip that is extended from the mounting part, and that covers a drainage hole formed in the door panel, wherein
the sub-lip is configured to be bendable by having a flexure part or a folding part.

2. The lower seal according to claim 1, wherein a notch or a thin-wall part is formed in the flexure part or the folding part of the sub-lip so as to facilitate the folding.
